(19) United States
(12) Patent Application Publication
(10) Pub. No.: US 2002/0188552 A1
(43) Pub. Date: Dec. 12, 2002

(54) Devices, softwares and methods for automated execution of conditional securities trade orders and interfaces for entering the same

(75) Inventors: Lawrence E. Kavounas, Carlsbad, CA (US); Gregory T. Kavounas, Vancouver, WA (US)

Correspondence Address: MARGER JOHNSON & MCCOLLOM PC, 1030 SW MORRISON STREET, PORTLAND, OR, 97205, US

(73) Assignee: Lawrence E. Kavounas, Carlsbad, CA (US)

(21) Appl. No.: 10/122,028

(22) Filed: Apr. 12, 2002

Related U.S. Application Data
(60) Provisional application No. 60/297,106, filed on Jun. 7, 2001.

(51) Int. Cl. G06F 17/60

(52) U.S. Cl. 705/37

(57) ABSTRACT

Devices, such as computers, softwares and methods for brokers and/or exchanges to permit trading entities (TEs) to enter conditional executable trade orders (CTOs). These are Trade Orders (TOs) that are executed according to a decision tree, which is followed depending on whether conditions are met or not. Each condition may be associated with the decision tree, or with a particular TO. Conditions include when a time is reached, a security price reaches a threshold, when an available balance becomes sufficient, when a prior TO has indeed been executed, etc. In a “chain” group of embodiments, TOs are given sequentially along at least a branch of the decision tree. At least one of them is a CTO. When the CTO is considered and its individual conditions are not met, it is not executed, which further prevents the next TO in the chain from becoming active (and its conditions, if any, from being considered). This permits day trading without real time supervision. In addition, methods and interfaces for a TE to enter such a chain of TOs for execution in a computer of a broker.

### CROSS REFERENCE TO RELATED APPLICATIONS

This application claims priority from U.S.A. Provisional Application No. 60/297,106, filed on Jun. 7, 2001, the disclosure of which is hereby incorporated by reference for all purposes.

### BACKGROUND OF THE INVENTION

1. Field of the Invention

The present invention is related to the field of securities trading, and more specifically to devices, softwares and methods for automated execution of conditional securities trade orders.

2. Description of the Related Art

In this document, certain terms are specially defined. They are also given in upper case. When in the plural number, they are written with a lower case “s” at the end. For example, a new term may be discussed as “X”, and be referred to in the plural number as “Xs”.

ST: “Securities Trading” (ST) is the exchange of securities. In practice, cash or other liquidity is on the one side of the exchange, so ST is the buying or selling of any one security.

E: ST happens in places called “Exchanges” (Es). Some big and well-known exchanges are the NYSE (New York Stock Exchange), the AMEX (American Exchange), the NASDAQ, and the CBOE.

TE: A trading entity (TE) is any one entity that wishes to trade. A TE is also called a trader. The definition of TE includes both institutions and individuals.

B: Normally a TE does not get direct access to the Es. Instead, a TE may access an E via intermediaries recognized by the Es, commonly known as “Brokers or Brokerage Houses” (Bs).

TO; ETO: Trade orders (TOs) by TEs are executed by Bs. More comprehensively, Bs provide among others the following services:

1. They provide to the TEs access to the Es.

2. They formulate the TE trade orders (TOs) into trade orders of a special format (ETOs). ETOs are such that the Es can understand, which is very useful because TEs are not always entirely familiar with the exact requirements of the Es.

3. They do the cash settlements with the TEs, thereby relieving the Es from the logistical requirement of having to do so.

4. They undertake the risk of fraudulent or accidental TOs, thereby relieving the Es of the associated risk.

C$; BOL$: Bs get paid for their services by collecting a commission (C$). In fact, for a single transaction, a B collects one C$ from the TE who is buying, plus one C$ from the TE who is selling. Bs may also assess their own additional odd-lot fees (BOL$) to cover their own costs of EOL$ (that they pay to the E) where applicable.

PI2E: Bs can also make more money from extensions of the above models.

That is in at least two ways.

A) Bs create Private, Internal, and/or secondary Es (PI2Es). This practice is possible when a B (or a pool of Bs) is large enough, to receive and process many TOs processed at the same time.

These PI2Es create gains for the B (or participating Bs) by netting: If a TO arrives to sell a security at about the same time as another TO arrives to buy the same security at the same price, the PI2E can subdivide the transaction into a common part and a disparate part. Moreover, the PI2E can effect the common part of the transaction internally, collecting all the associated fees. The PI2E can only send to the formal Es a new ETO for the disparate part.

Historically, Bs have found it profitable enough to translate TOs into ETOs and collect their fees.

Then the internet came, and has enabled Bs to create widely-accessible websites. These websites have been used cleverly with associated software to achieve many advantages.

First, the websites have enabled the Bs to disseminate vast volumes of information to TEs or prospect TEs and to answer questions for same, without having to employ personnel to do so in person. This demystifies the Es for many lay people, thus creating more TEs.

Second, the websites have enabled Bs to do much of their work, even the added volume, automatically, without needing to employ human agents. More specifically, TEs that are ordinary human beings input orders. Inputting is in a format where the software of the website formulates them as TOs automatically. Further, software aggregates TOs into ETOs for processing transactions, internally, as seen above. In addition, software sends ETOs to the Es, and processes them.

TC: After a transaction is executed, trade confirmations (TCs) about the TOs are sent, again automatically.

All this automation reduces overhead costs, which therefore lower transaction costs. Some of these have been passed on to customers.

Another consequence is that new Bs have entered the fray such as E*Trade, AmeriTrade, and Datek. These started out by being only internet based, and charge under $10 for the same service. They can do so because they were not saddled with the legacy of bricks-and-mortar infrastructure of the established Bs.

Another consequence of this automation arises from the fact that the trade confirmations (TCs) arrive now much faster than before (when they were being mailed by the post office). Indeed, they arrive by email, or show up on the interface of the website.

This fact gives to TEs a far better ability to control at what exactly price a security was transacted at. This gives them the confidence to make transactions for exploiting smaller variations in quoted prices, which were previously too small to control.

DT: This better ability has created a new class of TEs: the so-called Daytraders (DTs). DTs are TEs who buy and sell the same security very frequently (possibly several times during the same day) from the website of one or more Bs. They take advantage of the fact that price quotations on a website are nearly real time, and the confidence that their order will be executed almost instantaneously. They make profits by capitalizing on very small price fluctuations of the security. Day trading seems to have become its own industry, and Bs go out of the way to lure DTs, such as with better interfaces and further discounts.

DTs face a number of problems and limitations with the present systems. For example, there are limited exit options from various positions, and the DT must be alert for when such proper conditions arise. Such force the DTs to remain near their computer terminals to watch intently for price fluctuations at all times while the Es are open. This causes them to become burned out and thus to drop out, which limits income of the Bs. In addition, having to continuously watch the screen keeps them from being productive in other occupations.

An example of how exit options are limited is as follows: Some of the components of information needed for an ETO are presently the following:

QE1. Who the B is (not necessary in a PI2E comprised of a single B)

QE2. Who the TE is (not necessary in a formal E—the B knows that)

QE3. What security (usually identified via the “CUSIP” number)

QE4. Quantity

QE5. Buy or sell

QE6. Minimum price

QE7. Maximum price

QE8. What is the minimum quantity required, if applicable

QE9. ETO Expiration date/time

There are problems with QE6, QE7, QE8, QE9. Specifically, the Bs (a) do not offer to the TEs the full spectrum of options available, (b) force the TEs to learn and use needless jargon, and (c) needlessly limit the choices of the TEs. For example, in asking about QE9 (order expiration), B offers 4 choices:

1. Day only

2. Good Until Canceled

3. Fill Or Kill

4. Immediate Or Cancel

Accordingly, the B never offers to the DT the explicit option for choosing a date/time expiration specification to the TE. Yet it supplies one to the E.

Further, in asking about expiration, the B also defines QE8 in the last two options only: In option 3 QE8=zero, and in option QE4 Minimum=the entire order.

Worse, the B screens have separate places that offer options like “Minimum”, “All-or-none”, and “do-not-reduce”. These can only frustrate the user of the screens, but they are not needed either: After the user has entered the information in the screens, the B then simplifies the information in constructing the ETO.

Another problem with present systems is compulsory down time. For example, currently when a B receives a TO, it processes it. Processing is performed by any number of diverse actions. These include that the TO

1. is fulfilled completely in a single trade

2. is fulfilled completely in multiple, partial trades

3. is canceled before any of it gets fulfilled

4. is canceled after only a portion of it gets filled

5. expires before any of it gets filled

6. expires after only a portion of it gets filled.

So, after entering the TO, the DT must wait for the TC. And if partial order fulfillments are acceptable and implemented, there can be multiple TCs for a single TO.

Waiting for the one or more TCs is filled with anticipation, while nothing is happening. While the DT waits, they do not know which actions will be taken. This contributes to bum out.

When a DT eventually receives a TC, he has to process it, and then start typing the next order. The length of time it takes to type in an order is further “downtime”—i.e. represents an opportunity cost for the DT.

All of the prior art has a single focus: Once a trade order (TO) is entered or placed, it is to be executed immediately. The TE (such as a DT) needs to be there, to place it in real time. Once placed, the only control retained over it is by canceling it, or by having it expire after some time. Needing to be there is what burns out DTs.

### BRIEF SUMMARY OF THE INVENTION

The present invention overcomes these problems and limitations of the prior art.

Generally, the present invention provides devices, such as computers, softwares and methods for brokers and/or exchanges to permit trading entities (TEs) to enter conditional executable trade orders (CTOs). These are Trade Orders (TOs) that are executed according to a decision tree, which is followed depending on whether conditions are met or not. Conditions include when a time is reached, a security price reaches a threshold, when an available balance becomes sufficient, or whether another trade order has been executed, etc.

In the present invention the conditions may be associated with the decision tree or with a particular TO. Some of that association may be interchangeable equivalently, as a matter of parsing, encoding, and so on. When a TO is associated with at least one condition, it is rendered into a CTO. When a condition is part of the decision tree, it may direct execution into different branches.

In a group of embodiments (“chain”), TOs are given sequentially along at least a branch of the decision tree. At least one of them is a CTO. When the CTO is considered and its individual conditions are not met, it is not executed. In the chain embodiments, not executing the CTO prevents the next TO in the chain from becoming active (and its conditions, if any, from being considered). Only after the first TO is executed, does the next TO become active.

The invention offers the advantage that the CTOs in the chain in effect contain trade orders (TOs) that are entered in the future, and only when the conditions are met. They are entered in the future only after a prior TO has been executed, which is a type of a condition.

In one application, a Day Trader (DT) can enter a chain of repeating pairs of complementary conditional buy and sell orders for a security. The invention will attempt to execute these trades, one CTO at a time. If the prices behave as the DT expects them, then the DT will have a profit. Otherwise, the orders will simply not be executed. In either case, after the DT enters the chain of orders, he can walk way from their computer, free to pursue other occupations.

The invention also provides methods and interfaces for a TE to enter such a chain of TOs for execution in a computer of a broker.

The invention will become more readily apparent from the following Detailed Description, which proceeds with reference to the drawings, in which:

### BRIEF DESCRIPTION OF THE DRAWINGS

FIG. 1 describes an arrangement of devices according to embodiments of the invention.

FIG. 2 is an illustration of a data structure representing a Conditional Trade Order (CTO) according to an embodiment of the invention.

FIG. 3 is an illustration of a data structure representing a unitary chain of CTOs according to an embodiment of the invention.

FIG. 4 is a flowchart illustrating a method according to an embodiment of the present invention.

FIG. 5A is a diagram of a time evolution of a price of a security, and for which a Day Trader (DT) has planned conditional trade orders according to the method of FIG. 4.

FIG. 5B is a diagram of a time evolution of a polling fee balance of the DT of FIG. 5A, when checking the security price of FIG. 5A and trading on it with resetting.

FIG. 5C is a time diagram illustrating the trades resulting from the method of FIG. 4, as applied to the checked security price of FIG. 5A, and with the polling fee balance of FIG. 5B.

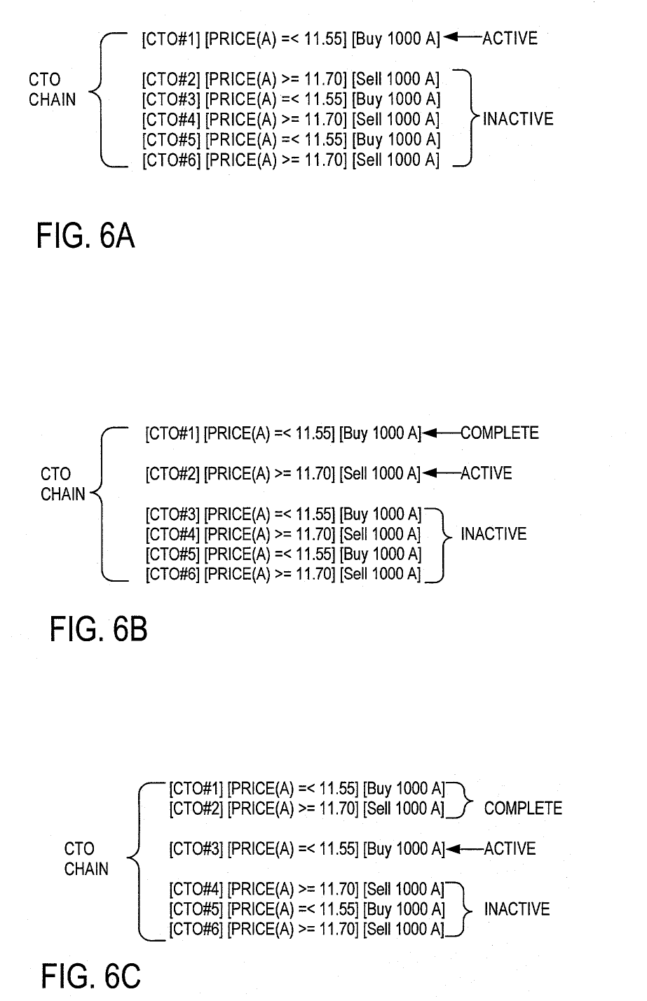

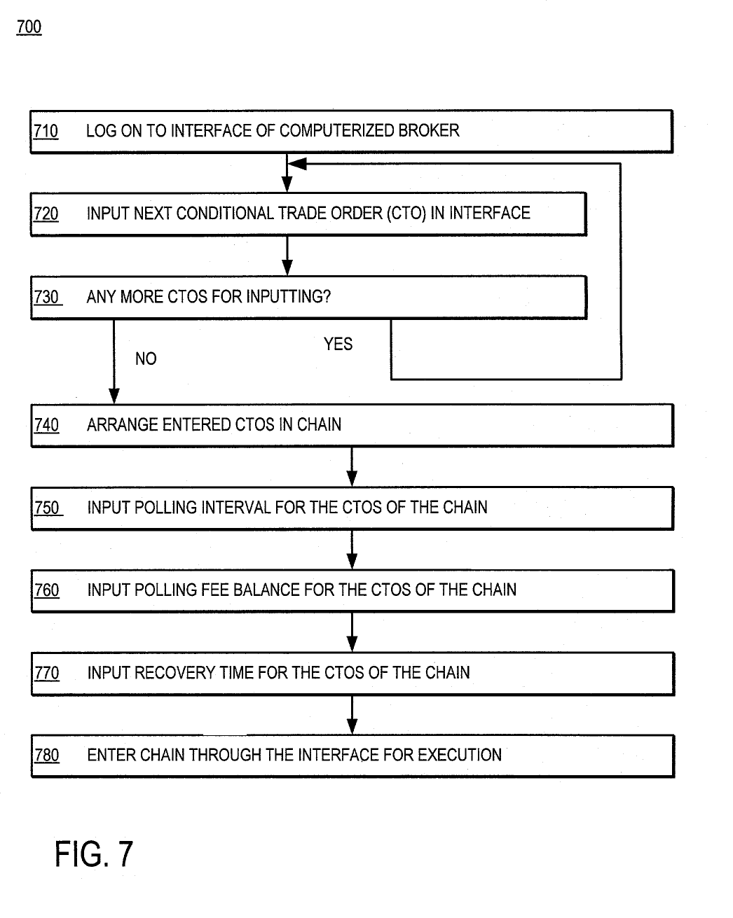

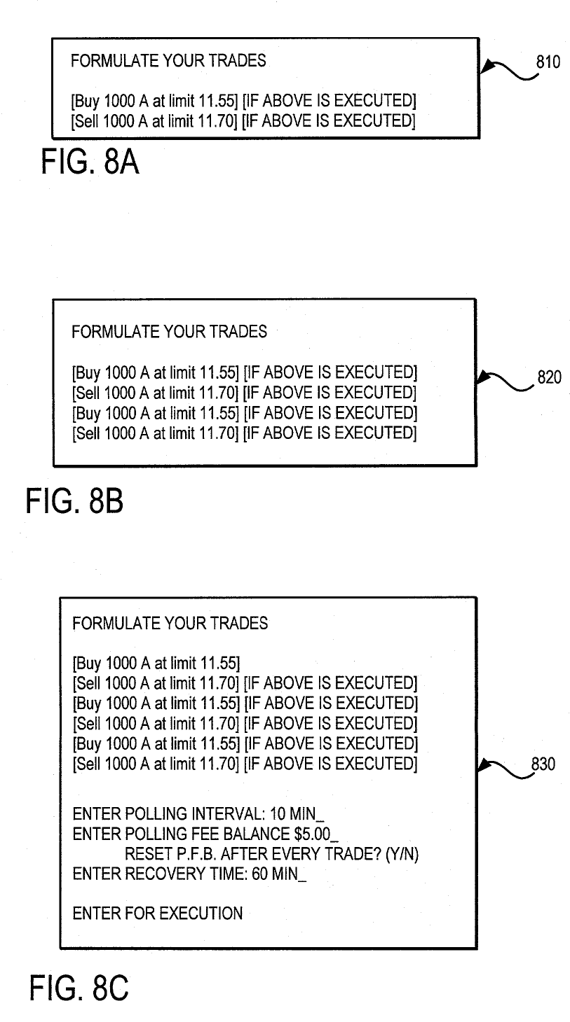

FIG.S 6A, 6B, 6C show snapshots of a chain of CTOs as pending during various time intervals of the graph of FIG. 5C, that have effectuated the trades of FIG. FIG. 7 is a flowchart illustrating a method according to another embodiment of the present invention.

FIG.S 8A-8C show successive sample screens of an interface for inputting a chain of CTOs to implement a method of FIG. 7.

### DETAILED DESCRIPTION OF THE PREFERRED EMBODIMENT(S)

As has been mentioned, the present invention provides devices, such as computers, softwares and methods for brokers and/or exchanges to permit trading entities (TEs) to enter a series (“chain”) of conditional executable trade orders (CTOs). In some embodiments, these are executed one at a time, and only when a condition is met. The invention also provides a method for a TE to enter such a chain of CTOs in a computer. The invention is now described in more detail.

The devices of the invention may be computers. In other words, the present invention may be implemented by one or more devices that include logic circuitry. The device performs functions and/or methods as are described in this document. The logic circuitry may include a processor that may be programmable for a general purpose, or dedicated, such as microcontroller, a microprocessor, a Digital Signal Processor (DSP), etc. For example, the device may be a digital computer like device, such as a general-purpose computer selectively activated or reconfigured by a computer program stored in the computer.

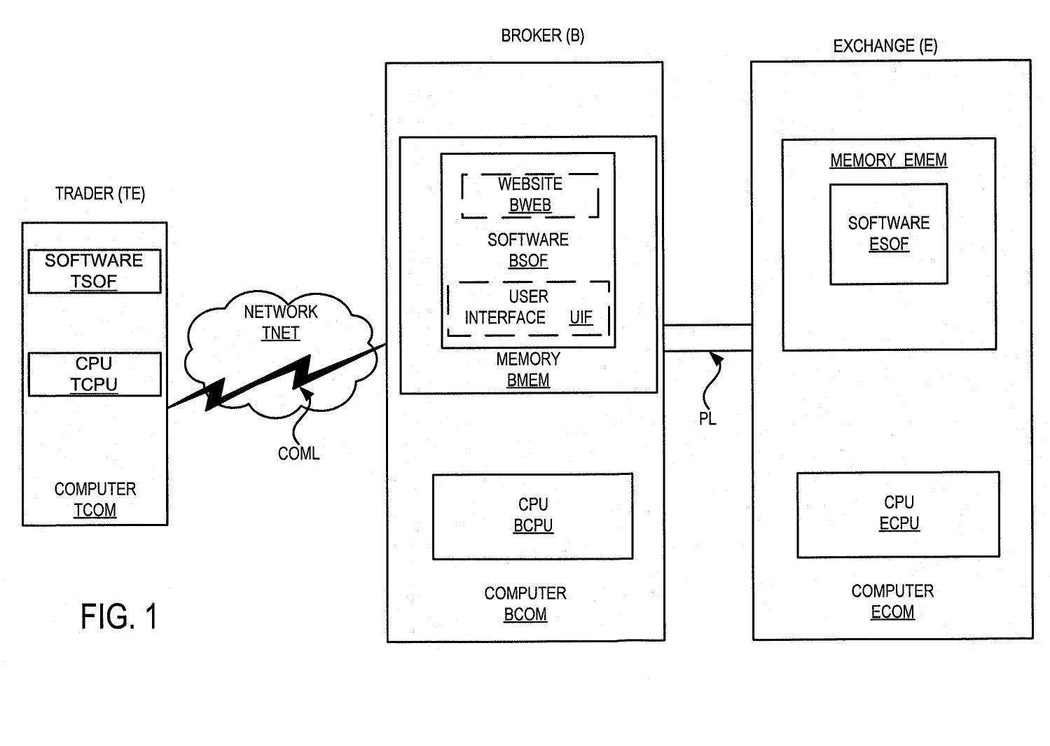

Referring now to FIG. 1, an arrangement is shown according to an embodiment of the invention.

A trader TE has a computer TCOM, which includes a Central Processing Unit (CPU) TCPU and software TSOF. The trader establishes a communication link COML through a network TNET.

A broker B has a computer BCOM, which includes a CPU BCPU and a memory BMEM. Communication link COML is with computer BCOM, so that website BWEB is seen by a screen (not shown separately in FIG. 1) of computer TCOM.

Memory BMEM includes software BSOF, which may include a website BWEB. Software BSOF preferably also includes a user interface UIF made according to an embodiment of the invention. User interface UIF is accessed by communication link COML, and is described in more detail below.

An exchange E has a computer ECOM, which includes a CPU ECPU and a memory EMEM. Memory EMEM includes software ESOF. Computer ECOM is coupled with computer BCOM via a link PL.

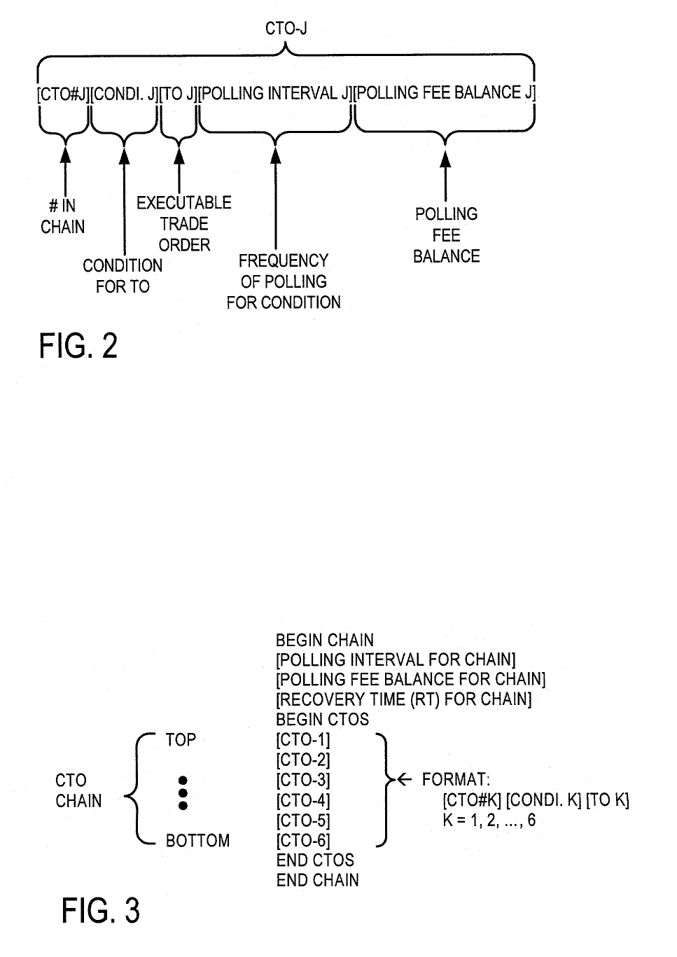

Referring now to FIG. 2, a data structure is illustrated representing a single Conditional Trade Order CTO-J made according to an embodiment of the invention. The shown CTO is assumed to be the J-th CTO of a chain or series of CTOs, of which the remaining elements are not shown. That is why the shown particular fields have the index J.

Conditional Trade Order CTO-J has a field TO J that includes an executable trade order (TO). The TO may be derived by parsing CTO-J, or otherwise.

Conditional Trade Order CTO-J optionally also has a field CTO#J, which is a numerical index of CTO-J within the chain. This is necessary only in a few cases.

Importantly, Conditional Trade Order CTO-J has a field CONDI. J, which stores at least one condition for executing the executable trade order of field TO J. Naturally, other arrangements have the condition associated with the executable trade order elsewhere in the data structure.

There may be more than one conditions for a single CTO according to the invention. In that case, the field CONDI.J has two conditions, or equivalently there may be two condition fields, etc.

Each of the conditions may be any condition that a computer can ascertain whether it is met. There is no limitation as to the type.

One such type of a condition is that execution is enabled (the TO becomes “active”) only after a prior TO has been executed. This is implemented inherently by a chain.

Another type of condition is when a security price reaches a threshold. Examples of that are discussed later in this document.

One more type of condition is whether a verifiable amount is sufficient. The amount may be a customer balance. For example, a security price may be oscillating wildly, and the customer wants to purchase a block of it at an advantageously low price. The customer could arrange checking the price of a block against their balance, which in turn may be variable.

Yet another type of a condition is the arrival of a certain time. The time may be absolute, for example, the condition may be TIME>11:43 AM. The condition would be met after 11:43 am of an indicated day. In this case the condition effectuates a delayed activation. In that case, there can be an additional field QE10: TO activation date/time. Optionally QE10 is asked only if QE8 is implemented.

The time may also be given in relative terms. For example, the condition may be stated as TIME>TIME[execution_of_CTO#(J−1)]+0:30. It will be recognized that this example is also inherently multiple conditions. The first condition is that another CTO (the one prior in the chain) must be executed, and the second condition is that another 30 minutes must pass. In this case, the usefulness of the numerical index field CTO#J is apparent. It will be appreciated that the later described recovery time (RT) is one such type of multiple conditions.

In one set of embodiments, the CTO is then stored by the B. When the activation day/time of field QE10 arrives, B forwards it to the E, which in turn executes it in real time.

In another set of embodiments, the CTO is forwarded immediately to the E, and is stored by E. Then, when the activation day/time of field QE10 arrives, E executes it in real time.

Conditional Trade Order CTO-J optionally also has a field POLLING INTERVAL J, which dictates how often there should be checking as to whether the condition of field CONDI. J is met. In other embodiments, the polling interval is the same for all CTOs in the chain, and thus need not be given with every CTO.

Conditional Trade Order CTO-J optionally also has a field POLLING FEE BALANCE J, which dictates what is the total budget for checking every time whether the specific condition of the CTO is met. A conveniently implied condition is that the Polling Fee Balance is larger than zero or a threshold. The threshold may be the polling fee.

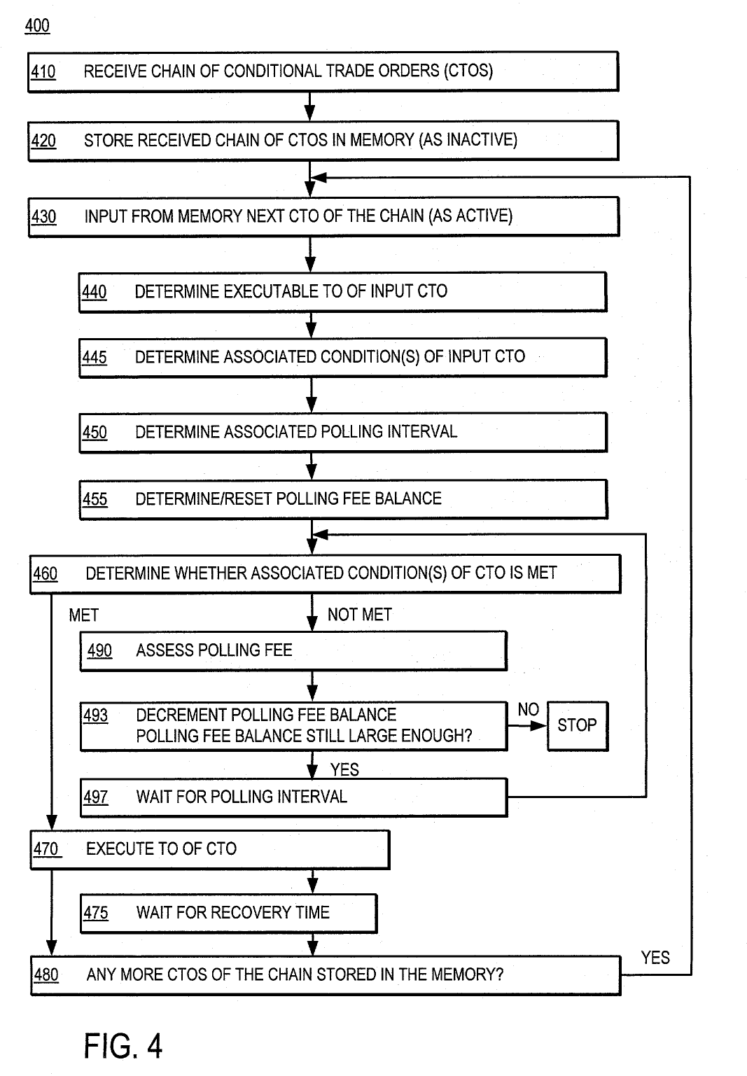

Referring now to FIG. 3, a data structure according to the invention is shown representing a plurality of CTOs, identified as CTO-K, where K is an index K=1, 2, . . . , 6. The CTOs form a CTO chain or CTO series, whose top CTO is the first one (CTO-1), and whose bottom CTO is the last one (CTO-6) in the chain. Remaining CTOs (e.g. CTO-2, CTO-3, CTO-4, CTO-5) are arranged sequentially and successively between the top and the bottom ones.

The data structure of FIG. 3 further has a context for all the CTOs in the chain. The context provides fields for beginning and ending of the CTOs (BEGIN CTOS, END CTOS), and for beginning and ending of the whole chain (BEGIN CHAIN, END CHAIN).

It will be appreciated that, for the data structure of FIG. 3, a single field for the polling interval and the polling fee balance need be given for the entire chain. This way that information is conveyed in fields other than the individual CTOs. Accordingly, the individual CTOs have a data structure which, when compared to that of FIG. 2, omits the last two fields.

The data structure of FIG. 3 further includes a field for a Recovery Time RT. The value of that will be appreciated from the below.

Although here the CTO chain is shown as a linear series of successive CTOs, that is only one embodiment of the invention. Other embodiments of the invention may have a CTOs arranged other than linearly, for example in a decision tree that branches off to different chains of CTOs. In addition, branches may be joining.

Branching may be accomplished by inserting branching commands between the TOs of the chain. The commands may be based on branching conditions while not referring to TOs, etc. A different TO (or CTO) may then be considered, depending on whether or not a branching condition is met.

In some embodiments, more than one TOs may be enabled at the same time. In those cases, those TOs in the chain may be equivalently implemented as not having individual conditions (i.e. not as CTOs).

The person skilled in the art will be able to come up with many such types of data structures, for conveying the instructions of the group of TOs. Those would be created as the interface receives inputs of the chain.

Moreover, the invention additionally provides methods, which are described below. The methods and algorithms presented herein are not necessarily inherently associated with any particular computer or other apparatus. Rather, various general-purpose machines may be used with programs in accordance with the teachings herein, or it may prove more convenient to construct more specialized apparatus to perform the required method steps. The required structure for a variety of these machines will become apparent from this description.

In all cases, there should be borne in mind the distinction between the method the invention itself and the method of operating a computing machine. The present invention relates both to methods in general, and also to steps for operating a computer and for processing electrical or other physical signals to generate other desired physical signals.

The invention additionally provides programs, and methods of operation of the programs. A program is generally defined as a group of steps leading to a desired result, due to their nature and their sequence. A program made according to an embodiment of the invention is most advantageously implemented as a program for a computing machine, such as a general-purpose computer, a special purpose computer, a microprocessor, etc.

The invention also provides storage media that, individually or in combination with others, have stored thereon instructions of a program made according to the invention. A storage medium according to the invention is a computer-readable medium, such as a memory, and is read by the computing machine mentioned above.

The steps or instructions of a program made according to an embodiment of the invention requires physical manipulations of physical quantities. Usually, though not necessarily, these quantities may be transferred, combined, compared, and otherwise manipulated or processed according to the instructions, and they may also be stored in a computer-readable medium. These quantities include, for example electrical, magnetic, and electromagnetic signals, and also states of matter that can be queried by such signals. It is convenient at times, principally for reasons of common usage, to refer to these quantities as bits, data bits, samples, values, symbols, characters, images, terms, numbers, or the like. It should be borne in mind, however, that all of these and similar terms are associated with the appropriate physical quantities, and that these terms are merely convenient labels applied to these physical quantities, individually or in groups.

This detailed description is presented largely in terms of flowcharts, display images, algorithms, and symbolic representations of operations of data bits within at least one computer readable medium, such as a memory. An economy is achieved in the present document in that a single set of flowcharts is used to describe both methods of the invention, and programs according to the invention. Indeed, such descriptions and representations are the type of convenient labels used by those skilled in programming and/or the data processing arts to effectively convey the substance of their work to others skilled in the art. A person skilled in the art of programming may use these descriptions to readily generate specific instructions for implementing a program according to the present invention.

Often, for the sake of convenience only, it is preferred to implement and describe a program as various interconnected distinct software modules or features, individually and collectively also known as software and softwares. This is not necessary, however, and there may be cases where modules are equivalently aggregated into a single program with unclear boundaries. In any event, the software modules or features of the present invention may be implemented by themselves, or in combination with others. Even though it is said that the program may be stored in a computer-readable medium, it should be clear to a person skilled in the art that it need not be a single memory, or even a single machine. Various portions, modules or features of it may reside in separate memories, or even separate machines. The separate machines may be connected directly, or through a network, such as a local access network (LAN), or a global network, such as the Internet.

In the present case, methods of the invention are implemented by machine operations. In other words, embodiments of programs of the invention are made such that they perform methods of the invention that are described in this document. These may be optionally performed in conjunction with one or more human operators performing some, but not all of them. As per the above, the users need not be collocated with each other, but each only with a machine that houses a portion of the program. Alternately, some of these machines may operate automatically, without users and/or independently from each other.

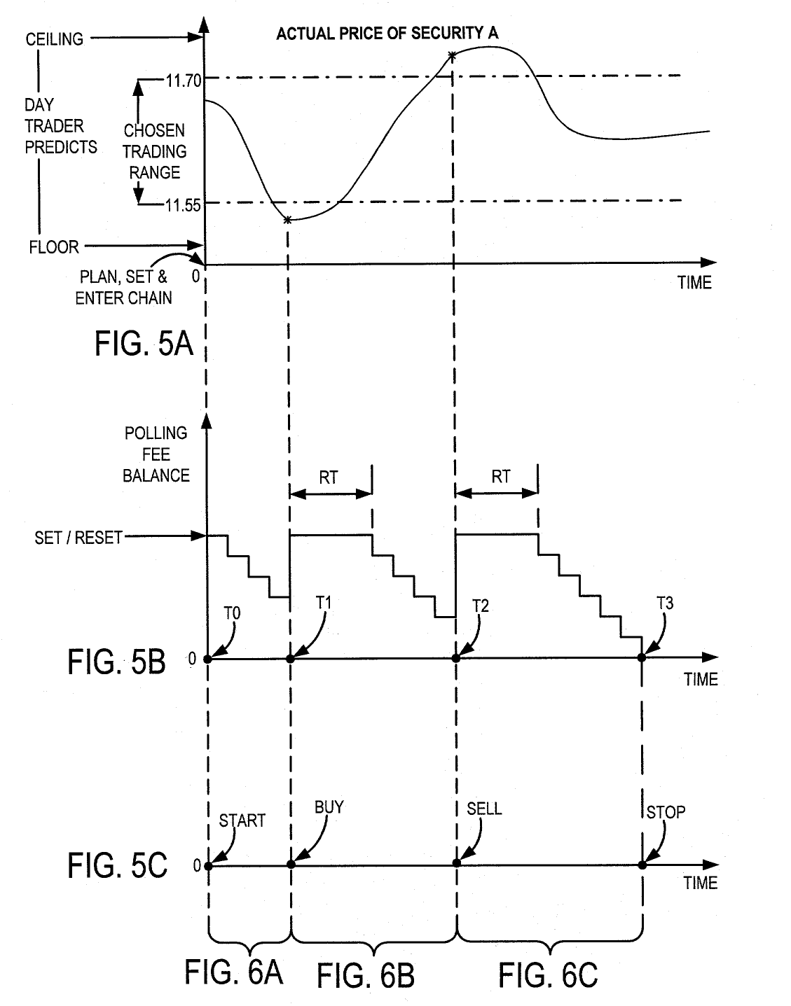

Referring now to FIG. 4, a flowchart 400 is used to illustrate a method according to an embodiment of the invention. The method of flowchart 400 may also be practiced by computer BCOM or computer ECOM of FIG. 1 in accommodating a TE, or a broker B or a pool of brokers, etc.

According to a box 410, a chain of conditional trade orders (CTOS) is received. The chain may have any data structure, and the one shown in FIG. 3 is only an example. The chain includes at least a first CTO and a second CTO, each of which includes a respective executable trade order (TO). In addition, a third CTO may be included, and so on.

According to an optional next box 420, the received chain of CTOS is stored as inactive. Equivalently, the top or first CTO is not stored as inactive.

Storing may be in a memory, such as BMEM or EMEM of FIG. 1. For example, the second CTO is stored without being executed, at least until the TO of the first CTO has been first executed. If a third CTO is included, then it, too is stored without being executed, at least until the TO of the second CTO has been first executed.

According to an optional next box 430, the next CTO of the chain is input from the memory, and becomes active. The first time box 430 is executed, what is actually input is the top TO of the chain. If the top CTO has not been stored in the memory as inactive, then it is already active and box 430 is skipped.

According to an optional next box 440, an executable TO of the input CTO is determined. Determining may be by parsing the input CTO, to find the appropriate field and extract data from it.

According to a next box 445, an associated condition of the input CTO is determined. Determining may be by parsing the input CTO, to find the appropriate field and extract data from it.

According to an optional next box 450, an associated polling interval is determined. Determining may be by parsing the input CTO, to find the appropriate field and extract data from it.

According to an optional next box 455, a polling fee balance is determined. Determining may be by parsing the input CTO, to find the appropriate field and extract data from it. If this is not the first time this box is executed, then instead the polling fee balance may be reset.

According to a next box 460, it is determined whether the associated condition is met. Determining may include looking at the clock, looking at the instant price of a security, and so on.

If at box 460 the condition is met, then according to a next box 470, the executable trade order (TO) of the input CTO is executed. For purposes of this discussion, “executing the TO” means the action whereby the B satisfies a TO either internally, or by submitting it PI2Es or to the formal Es for fulfillment. Alternately, if it is the E practicing the method, it means commencing fulfilling the order. At this time, other collateral actions may take place, such as assessing a trading fee commission (C$), sending a trade confirmation (TC) to the TE, and so on.

According to an optional next box 475, a recovery time is allowed to pass. Waiting for the recovery time may be desirable, if it is hypothesized that a next TO in the chain will not become eligible for a while, and there is no need to check as frequently. This will economize on polling fees.

According to an optional next box 480, it is inquired whether there are any more CTOs of the chain stored in the memory. If yes, execution returns again to box 430, and the next CTO is considered.

Importantly, if at box 460 the condition is not met, then the executable trade order (TO) of the input CTO is not executed.

According to an optional next box 490, a polling fee is assessed. That may be for the service of verifying whether the condition was met. Of course, the polling fee is preferably much smaller than the trading fee commission (C$).

The polling fee may be assessed in a number of ways (once per checking, once per trade, once every X times of checking, etc.). If proportional to the times of checking, imposing the polling fee will stratify the customers according to the polling interval they will have requested. Those who are willing to check more often (and pay more often), will receive a quicker response.

According to an optional next box 493, a polling fee balance is decremented. Decrementing is by an amount determined by the polling fee of box 490. Then it is inquired whether the polling fee balance is still large enough, e.g. for another polling. If not, then execution may stop, unless other arrangements have been made.

If yes, then according to a next box 497, some time is allowed to pass, e.g. that of a polling interval. The time may be the same every time box 497 is executed, or different times may be implemented. Execution then returns to box 460, and it is determined again whether the associated condition is met.

A TE might set the polling interval in view of the polling fee, and their own preference for trading. As the TE has a mental model for how quickly a price of a security moves, the TE might have to decide how quickly to respond to that movement (more quickly by checking more often, which is by setting shorter polling interval). This would have to be balanced with how much it costs to check (polling fee).

The invention may be used to implement a number of conditional trading schemes. A simple one is described below.

The invention may be used advantageously in connection with the practice of Day Trading. This is accomplished by inputting a chain of multiple and repeating CTOs, which are executed successively for profit.

Referring now to FIG. 5A, a day trader (DT) contemplates trading on variations of the future price of a security A, and tries to predict them. The DT contemplates in advance, i.e. the DT predicts without looking at the right half of FIG. 5A. Naturally, the DT will profit more for predicting correctly.

The contemplating DT predicts that the price of security A will move between a price floor of 11.50 and a price ceiling of 11.75. The DT further predicts that the price will oscillate repeatedly between the floor and the ceiling.

The DT intends to profit from the repeated oscillation. Accordingly, the DT wants to trade in the range between 11.55 and 11.70, by buying at 11.55 (or below) and selling at 11.70 (or above). The DT intends to profit from each pair of successive Buy-and-Sell transactions. Supposing that C$=$7, and the TE trades 1000 units, each pair of Buy-and-Sell will net the TE a profit of: 1000×(11.70−11.55)−2×7=$136. This is more than 1%, and can be done many times in a single day. The profit will be less, however, if a polling fee is charged.

As can be seen in FIG. 5A, at time 0 the DT loads the chain with the CTOs. The DT can either wait and watch it unfold, or leave it and see what happened later.

FIG. 5A also shows the later variations of the price of security A. The security price in this example is given as unique, but that is done only for simplicity. The person skilled in the art will discern that in fact there is an ask price and a bid price, which move in tandem with each other.

As seen in FIG. 5A, the price eventually does move down to below 11.55, then above 11.70, but then it drops again. But it does not drop again below 11.55. In other words, the DT's prediction was only partially correct.

Referring also to FIG. 5B, a time evolution is given of a polling fee balance that the DT maintains with the broker. The balance, in this embodiment, is set by the DT, and reflects how much money they are willing to spend in checking the price of the security as per FIG. 5A.

In the embodiment of FIG. 5B, every time the price is checked (once every polling period), the balance is decremented by the polling fee. When checking reveals that a price has been reached, then the DT may have advantageously given the instruction that the balance be reset (the money is budgeted from the profit of each pair of transactions).

Referring now also to FIG. 5C, the actual transactions are monitored.

More particularly, when the price is checked again at time T1, it is found to be below 11.55 (from FIG. 5A). Thus, there is a purchase of the security on behalf of the DT (FIG. 5C). The polling fee balance is then reset (FIG. 5B).

Then there is no checking for a recovery time period RT, since the price would not have moved back up very quickly. This preserves the polling fee balance for a while.

Then there is checking again, while decrementing the polling fee balance every time. At time T2 the price is found to have moved above 11.70, and there is a sale of the security bought at time T1.

The DT thus has made a profit, while he did not have to be attending. Planning these transactions includes determining the initial polling fee balance, and the polling interval. The DT made a profit, out of which the DT paid commissions for the purchase, the sale, and the polling fees.

The profit according to the invention is indeed less, if polling fees are assessed. Those are easily offset by the fact that the DT need not spend their time in front of their own computer screen, but can instead do something more productive with that time.

After another recovery time RT interval, the checking begins again. This time, however, the DT's prediction of the movement of the security price fails. The price does drop, but too slowly. The polling fee balance reaches zero at time T3, and then trading stops.

FIG.S 6A, 6B, 6C show snapshots of a chain of CTOs that caused the transactions of FIG. 5C. The snapshots are further shown as pending during various time intervals of the graph of FIG. 5C. The chain may well be that of FIG. 3.

It will be recognized that the chain of FIG.S 6A, 6B, 6C includes successive pairings of buy and sell orders. Every time a pairing is executed, there is a profit.

More particularly, between times 0 and T1, only the top CTO (CTO#1) is active, i.e. pending. All the others are inactive, stored.

Between times T1 and T2, only CTO#2 is active. CTO#1 has been completed, and the others are inactive.

Between times T2 and T3, CTO#1 and CTO#2 have been completed. They are a pairing, which result in a profit. CTO#3 is active, which is identical to CTO#1, and so on.

As has been mentioned, the invention also provides methods for entering chains of CTOs, and interfaces for doing the same. The interfaces are also software, subject to the comments above. An interface according to the invention may be on a website of the broker, or a complementary interface residing on a computer of the DT.

The interfaces of the invention may show the snapshots of FIG.S 6A, 6B, 6C, as they are being executed. The DT can watch them unfold, without having to participate. But he does not even need to be there. The DT can even turn off the computer, and receive a report at the end of the day.

Referring now to FIG. 7, a flowchart 700 is used to illustrate a method according to another embodiment of the invention. Flowchart 700 may be practiced by a DT, entering CTOs, alone or in a chain, such as that of FIG.S 6A, 6B, 6C. The method of flowchart 700 may also be practiced by someone using an interface made according to an embodiment of the present invention, such as user interface UIF of FIG. 1.

According to a box 710, an interface is used for logging on. The interface is typically of a computerized broker. The interface may reside on the TE's computer in part. Or it may reside on the broker's computer, and be wholly accessed on line.

Then a plurality of CTOs are input in the interface. This may take place in a number of ways according to the invention. One such way is as follows.

According to an optional next box 720, a next conditional trade order (CTO) is input in the interface. According to a next box 730, it is inquired whether there are any more CTOs for inputting. If yes, execution returns to box 720, and another one is input.

If not, it means they are all input. Then according to a next box 740 the entered CTOs are arranged as successive in a chain. At this time, the CTO#s may be assigned by the interface. Alternately, box 740 may be practiced simultaneously with box 720 or box 730 or both.

According to an optional next box 750, a polling interval for the CTOs of the chain is input.

According to an optional next box 760, a polling fee balance for the CTOs of the chain is input.

According to an optional next box 770, a recovery time for the CTOs of the chain is input.

According to a next box 780, the chain is entered through the interface to a computer of the broker for execution. Entering involves communication between computers.

Referring now to FIG.S 8A, 8B, 8C, portions of successive screens 810, 820, 830 are shown of an interface UIF made according to the present invention. Screens 810, 820, 830 are just one embodiment, for assisting the client (TE, DT) to enter a chain of CTOs that will result in the chain of FIG. 3 and FIG. 6A.

In screens 810, 820, 830 the TE is asked to formulate their trade orders, either as direct (independent) or as conditional (dependent). In addition, the TE is given also other user friendly instructions.

While the TE only sees the user friendly instructions in these screens 810, 820, 830, more complex computer instructions are used to produce these screens 810, 820, 830. Mathematics, variables, and a whole programming language can be defined on top of such a facility. Other variables can be “date”, my_position(A), etc.

In preparing for a repeating day trade (as per the model of FIG. 5A), a TE that is a Day Trader (DT) enters (at screen 810) a pair of two complementary conditional trade orders. They are complementary, because the second one sells what the first one buys. Execution of both, therefore, will leave the DT with no position in the stock (but only a profit).

The trade orders are presently shown as conditional, because they include a condition “[IF ABOVE IS EXECUTED]”. In this embodiment, the condition is entered explicitly. In other embodiments of the invention, the condition may be implied by the very fact that some of the orders are below others, or are entered in a special format, such as a special portion of the screen, etc.

It should be noted that, of those two CTOs, the first one will eventually not be conditional on a previous order. Indeed, the chain will have to start with a top link, one that has no prior link. The condition “[IF ABOVE IS EXECUTED]” is given, however, to facilitate the copying below.

As seen in the next screen 820, the TE copies the pair of CTOs of screen 810, so that they appear again. The person skilled in the art will discern many ways to enable the DT to perform such copying, e.g. by highlighting the original pair and hitting a “COPY” screen button of the interface.

After copying, there are two pairs (four orders) in the stack that the TE is developing. Copying may be for many times.

As seen in the next screen 830, the TE copies again the pair of CTOs of screen 810. This way there are three pairs (six orders) in the stack.

In addition, while at screen 830 the DT removes the condition “[IF ABOVE IS EXECUTED]” of the top trade order in the chain. This way it will be active, after it is translated to what is shown in FIG. 6A. In other words, the condition was placed in screen 810 (and remained through screen 820), only to facilitate copying. In other, equivalent embodiments, the condition could be removed from screen 820 and copy only the second pair, etc.

By the time screen 830 is reached, the user interface UIF gives additional options. The UIF may do so upon recognizing that a stack of trade orders are being entered, which are intended to be successive in a chain.

The additional options refer to the chain. They ask for a polling interval, a recovery time, and a polling fee balance. They may further ask for an instruction as to whether the polling fee balance is to be reset. Resetting before all the conditional trade orders of the chain are executed can be periodic or otherwise. If not reset, then trading stops when the balance reaches zero.

The final option is to enter the entire chain of trades for execution by the broker. Entering is an instruction to the broker to execute the trades, with the conditions given.

A person skilled in the art will be able to practice the present invention in view of the description present in this document, which is to be taken as a whole. Numerous details have been set forth in order to provide a more thorough understanding of the invention. In other instances, well-known features have not been described in detail in order not to obscure unnecessarily the invention.

While the invention has been disclosed in its preferred form, the specific embodiments as disclosed and illustrated herein are not to be considered in a limiting sense. Indeed, it should be readily apparent to those skilled in the art in view of the present description that the invention may be modified in numerous ways. The inventor regards the subject matter of the invention to include all combinations and subcombinations of the various elements, features, functions and/or properties disclosed herein.

The following claims define certain combinations and subcombinations, which are regarded as novel and non-obvious. In terms of combinations and subcombinations, when something is called a “first” CTO in the claims, that may be by considering it in relation to a second CTO, and not necessarily be the top one in a chain of CTOs.

Additional claims for other combinations and subcombinations of features, functions, elements and/or properties may be presented in this or a related document.

The invention claimed is:

1. A device comprising:
means for inputting a first conditional trade order (CTO) that includes a first executable trade order (TO);
means for inputting a second CTO that includes a second executable TO;
means for storing the second CTO without executing the second TO at least until the first TO has been executed;
means for determining a first condition associated with the first TO;
means for determining whether the first condition is met; and
means for waiting for a polling interval without executing the first TO if the first condition is not met, means for then determining again whether the first condition is met.

2. The device of claim 1, further comprising:
means for parsing the first CTO to determine the first condition.

3. The device of claim 1, in which
the first condition is a price of a security.

4. The device of claim 1, in which
the first condition is that a verifiable amount is sufficient for executing the first TO.

5. The device of claim 4, in which
the verifiable amount is a customer balance.

6. The device of claim 1, further comprising:
means for parsing the CTO to determine the polling interval.

7. The device of claim 1, in which
the first condition is the occurrence of an event.

8. The device of claim 7, in which
the event is an execution of a prior trade order.

9. The device of claim 1, in which
the first condition is the passage of a preset amount of time after an occurrence of an event.

10. The device of claim 9, in which
the event is an execution of a prior trade order.

11. The device of claim 1, further comprising:
means for inputting a third CTO that includes a third executable TO; and
means for storing the third CTO without executing the third TO at least until the second TO has been executed.

12. The device of claim 1, further comprising:
means for assessing a polling fee in connection with determining again whether the first condition is met.

13. The device of claim 12, further comprising:
means for decrementing a polling fee balance by an amount determined from the polling fee.

14. The device of claim 13, further comprising:
means for determining if the decremented polling fee balance is less than a threshold balance; and
if not, then means for not determining again whether the associated condition is met, without executing the first TO.

15. The device of claim 1, further comprising:
means for then determining that the first condition is met;
means for determining a second condition associated with the first TO;
means for determining whether the second condition is met; and
means for waiting for a preset time without executing the first TO if the second condition is not met.

16. The device of claim 1, further comprising:
means for then determining that the first condition is met;
means for then executing the first TO;
means for then considering whether a branching condition is met; and
means for determining a second condition associated with the second TO if the branching condition is met and means for determining a third condition associated with a third TO if the branching condition is not met.

17. The device of claim 1, further comprising:
means for then determining that the first condition is met;
means for then executing the first TO;
means for determining a second condition associated with the second TO;
means for then determining whether the second condition is met; and
means for waiting for a preset time without executing the second TO if the second condition is not met.

18. The devic of claim 17, further comprising:
means for assessing a polling fee in connection with determining again whether the second condition is met.

19. The device of claim 17, further comprising:
means for resetting a polling fee balance; and
means for decrementing the polling fee balance responsive to determining again whether the second condition is met.

20. The device of claim 17, further comprising:
means for waiting for a preset recovery time responsive to determining that the first condition is met and prior to determining whether the second condition is met.

21. The device of claim 20, further comprising:
means for inputting the recovery time.

22. A device comprising:
means for logging on to an interface;
means for inputting in the interface a plurality of conditional trade orders arranged successively in a chain, in which a top conditional trade order in the chain may be executed but a second conditional trade order in the chain may not be executed prior to the top conditional trade order being executed; and
means for entering the arranged chain through the interface to a computer of a broker for execution.

23. The device of claim 22, in which
a pair of two of the conditional trade orders are complementary; and
inputting includes copying the pair a plurality of times.

24. The device of claim 22, further comprising:
means for inputting in the interface a polling interval associated with the conditional trade orders of the chain.

25. The device of claim 22, further comprising:
means for inputting in the interface a polling fee balance associated with the conditional trade orders of the chain.

26. The device of claim 22, further comprising:
means for inputting in the interface an instruction as to whether the polling fee balance is to be periodically reset before all the conditional trade orders of the chain are executed.

27. The device of claim 22, further comprising:
means for inputting in the interface a recovery time associated with the conditional trade orders of the chain.

28. An article comprising: a storage medium, the storage medium having instructions stored thereon, in which when the instructions a re executed by at least one device, they result in:
inputting a first conditional trade order (CTO) that includes a first executable trade order (TO);
inputting a second CTO that includes a second executable TO;
storing the second CTO without executing the second TO at least until the first TO has been executed;
determining a first condition associated with the first TO;
determining whether the first condition is met; and
if not, then waiting for a polling interval without executing the first TO, and
then determining again whether the first condition is met.

29. The article of claim 28, in which the instructions further result in:
parsing the first CTO to determine the first condition.

30. The article of claim 28, in which
the first condition is a price of a security.

31. The article of claim 28, in which
the first condition is that a verifiable amount is sufficient for executing the first TO.

32. The article of claim 31, in which
the verifiable amount is a customer balance.

33. The article of claim 28, in which the instructions further result in:
parsing the CTO to determine the polling interval.

34. The article of claim 28, in which
the first condition is the occurrence of an event.

35. The article of claim 34, in which
the event is an execution of a prior trade order.

36. The article of claim 28, in which
the first condition is the passage of a preset amount of time after an occurrence of an event.

37. The article of claim 36, in which
the event is an execution of a prior trade order.

38. The article of claim 28, in which the instructions further result in:
inputting a third CTO that includes a third executable TO; and
storing the third CTO without executing the third TO at least until the second TO has been executed.

39. The article of claim 28, in which the instructions further result in:
assessing a polling fee in connection with determining again whether the first condition is met.

40. The article of claim 39, in which the instructions further result in:
decrementing a polling fee balance by an amount determined from the polling fee.

41. The article of claim 40, in which the instructions further result in:
determining if the decremented polling fee balance is less than a threshold balance; and
if not, then not determining again whether the associated condition is met, without executing the first TO.

42. The article of claim 28, in which the instructions further result in:
then determining that the first condition is met;
determining a second condition associated with the first TO;
determining whether the second condition is met; and
if not, then waiting for a preset time without executing the first TO.

43. The article of claim 28, in which the instructions further result in:
then determining that the first condition is met;
then executing the first TO;
then considering whether a branching condition is met; and
if so, determining a second condition associated with the second TO,
else determining a third condition associated with a third TO.

44. The article of claim 28, in which the instructions further result in:
then determining that the first condition is met;
then executing the first TO;
determining a second condition associated with the second TO;
then determining whether the second condition is met; and
if not, then waiting for a preset time without executing the second TO.

45. The article of claim 44, in which the instructions further result in:
assessing a polling fee in connection with determining again whether the second condition is met.

46. The article of claim 44, in which the instructions further result in:
resetting a polling fee balance; and
decrementing the polling fee balance responsive to determining again whether the second condition is met.

47. The article of claim 44, in which the instructions further result in:
waiting for a preset recovery time responsive to determining that the first condition is met and prior to determining whether the second condition is met.

48. The article of claim 47, in which the instructions further result in:
inputting the recovery time.

49. An article comprising: a storage medium, the storage medium having instructions stored thereon, in which when the instructions are executed by at least one device, they result in:
logging on to an interface;
inputting in the interface a plurality of conditional trade orders arranged successively in a chain, in which a top conditional trade order in the chain may be executed but a second conditional trade order in the chain may not be executed prior to the top conditional trade order being executed; and
entering the arranged chain through the interface to a computer of a broker for execution.

50. The article of claim 49, in which
a pair of two of the conditional trade orders are complementary; and
inputting includes copying the pair a plurality of times.

51. The article of claim 49, in which the instructions further result in:
inputting in the interface a polling interval associated with the conditional trade orders of the chain.

52. The article of claim 49, in which the instructions further result in:
inputting in the interface a polling fee balance associated with the conditional trade orders of the chain.

53. The article of claim 49, in which the instructions further result in:
inputting in the interface an instruction as to whether the polling fee balance is to be periodically reset before all the conditional trade orders of the chain are executed.

54. The article of claim 49, in which the instructions further result in:
inputting in the interface a recovery time associated with the conditional trade orders of the chain.

55. A method comprising:
inputting a first conditional trade order (CTO) that includes a first executable trade order (TO);
inputting a second CTO that includes a second executable TO;
storing the second CTO without executing the second TO at least until the first TO has been executed;
determining a first condition associated with the first TO;
determining whether the first condition is met; and
if not, then waiting for a polling interval without executing the first TO, and
then determining again whether the first condition is met.

56. The method of claim 55, further comprising:
parsing the first CTO to determine the first condition.

57. The method of claim 55, in which
the first condition is a price of a security.

58. The method of claim 55, in which
the first condition is that a verifiable amount is sufficient for executing the first TO.

59. The method of claim 58, in which
the verifiable amount is a customer balance.

60. The method of claim 55, further comprising:
parsing the CTO to determine the polling interval.

61. The method of claim 55, in which
the first condition is the occurrence of an event.

62. The method of claim 61, in which
the event is an execution of a prior trade order.

63. The method of claim 55, in which
the first condition is the passage of a preset amount of time after an occurrence of an event.

64. The method of claim 63, in which
the event is an execution of a prior trade order.

65. The method of claim 55, further comprising:
inputting a third CTO that includes a third executable TO; and
storing the third CTO without executing the third TO at least until the second TO has been executed.

66. The method of claim 55, further comprising:
assessing a polling fee in connection with determining again whether the first condition is met.

67. The method of claim 66, further comprising:
decrementing a polling fee balance by an amount determined from the polling fee.

68. The method of claim 67, further comprising:
determining if the decremented polling fee balance is less than a threshold balance; and
if not, then not determining again whether the associated condition is met, without executing the first TO.

69. The method of claim 55, further comprising:
then determining that the first condition is met;
determining a second condition associated with the first TO;
determining whether the second condition is met; and
if not, then waiting for a preset time without executing the first TO.

70. The method of claim 55, further comprising:
then determining that the first condition is met;
then executing the first TO;
then considering whether a branching condition is met; and
if so, determining a second condition associated with the second TO;
else determining a third condition associated with a third TO.

71. The method of claim 55, further comprising:
then determining that the first condition is met;
then executing the first TO;
determining a second condition associated with the second TO;
then determining whether the second condition is met; and
if not, then waiting for a preset time without executing the second TO.

72. The method of claim 71, further comprising:
assessing a polling fee in connection with determining again whether the second condition is met.

73. The method of claim 71, further comprising:
resetting a polling fee balance; and
decrementing the polling fee balance responsive to determining again whether the second condition is met.

74. The method of claim 71, further comprising:
waiting for a preset recovery time responsive to determining that the first condition is met and prior to determining whether the second condition is met.

75. The method of claim 74, further comprising:
inputting the recovery time.

76. A method comprising:
logging on to an interface;
inputting in the interface a plurality of conditional trade orders arranged successively in a chain, in which a top conditional trade order in the chain may be executed but a second conditional trade order in the chain may not be executed prior to the top conditional trade order being executed; and
entering the arranged chain through the interface to a computer of a broker for execution.

77. The method of claim 76, in which
a pair of two of the conditional trade orders are complementary; and
inputting includes copying the pair a plurality of times.

78. The method of claim 76, further comprising:
inputting in the interface a polling interval associated with the conditional trade orders of the chain.

79. The method of claim 76, further comprising:
inputting in the interface a polling fee balance associated with the conditional trade orders of the chain.

80. The method of claim 76, further comprising:
inputting in the interface an instruction as to whether the polling fee balance is to be periodically reset before all the conditional trade orders of the chain are executed.

81. The method of claim 76, further comprising:
inputting in the interface a recovery time associated with the conditional trade orders of the chain.
